(19) United States
(12) Patent Application Publication
(10) Pub. No.: US 2024/0337302 A1
(43) Pub. Date: Oct. 10, 2024

(54) DAMPING DEVICE FOR REDUCING AND IN PARTICULAR BRAKING A MOVEMENT OF A SECOND COMPONENT MOVABLE RELATIVE TO A FIRST COMPONENT

(71) Applicant: ILLINOIS TOOL WORKS INC., Glenview, IL (US)

(72) Inventors: Christian BECK, Rottingen (DE); Christian STATT, Wurzburg (DE)

(21) Appl. No.: 18/625,963

(22) Filed: Apr. 3, 2024

(30) Foreign Application Priority Data
Apr. 4, 2023 (DE) 10 2023 108 611.1
Oct. 4, 2023 (DE) 10 2023 126 928.3

(51) Int. Cl. F16F 13/04; F16F 9/348

(52) U.S. Cl. CPC F16F 13/04; F16F 9/348; F16F 2230/0041; F16F 2230/0052; F16F 2230/30; F16F 2232/08

(57) ABSTRACT

A damper apparatus for reducing or braking a movement of a second part that is movable relative to a first part includes a first damper component connected to the first part, a second damper component connected to the first second part, and a damping mechanism. The first damper component is movable relative to the second damper component and the relative movement is or can be decelerated due to the damping mechanism. A switching mechanism with a first switching contact and a second switching contact is arranged or integrated on the second damper component. At least one actuating region is configured on the first damper component such that, when the first damper component moves relative to the second damper component, an electrically conductive connection is established or disconnected between the first switching contact and the second switching contact using the at least one actuating region of the first damper component.

### TECHNICAL FIELD

The invention relates generally to movement control apparatuses and in particular to damper apparatuses for reducing, and in particular braking, a movement of a second part movable relative to a first part.

In recent years, dampers or damper apparatuses have been developed in order to slow and/or control a relative movement of parts to one another. For example, vehicles are often equipped with various pivot assemblies (e.g., tailgates, freight doors, glove compartments, center console lids, engine hoods, etc.). The parts of pivot assemblies are connected to one another in order to rotate relative to one another, and one or more dampers are connected to the parts in order to regulate their rotational speed.

Similarly, linear dampers are also known, which reduce or decelerate a linear movement between two parts.

Certain known damper apparatuses are designed so as to dampen or decelerate the relative movement of parts that pivot due to gravity. If a part located further below (e.g., a glove box flap) is released in order to pivot relative to a part located further above (e.g., a dashboard), the damper apparatus slows the downwards rotation of the lower part.

Such damper apparatuses known in the prior art are often embodied as air dampers or hydraulic dampers, in which a working fluid (air, hydraulic fluid, or grease) is forced from a first working space into a second working space through an orifice or choke, as a result of which a force/motion introduced into the damper apparatus is dampened, i.e., reduced. Rotary dampers are also known, whose functionality is based on the shear principle.

The known damper apparatuses thus have a relatively complex construction, in which the scaling of the working spaces must be ensured. In particular, there is a risk that the systems will leak after some time and thus lose their damping function.

Moreover, damper apparatuses that operate with liquid working media, such as oil, have the disadvantage that the damping behavior is often temperature-dependent, because the viscosity of the damping liquid generally increases at low temperatures.

In the automobile sector, rotary dampers comprising a linear damper are frequently used in order to decelerate or dampen movements of parts such as glove compartment doors or movable flaps.

Such linear dampers with a rotary damper contained therein are disclosed, for example, in publication EP 0 846 886B1, in publication EP 1 344 958B1, or in publication DE 10 2006 000 940B4.

Conventional rotary dampers comprise a rotor which is rotatably mounted inside the rotary damper. A brake fluid, e.g., silicone oil, between the rotor and an outer wall of the rotary damper provides a braking damping when the rotor rotates in the rotary damper. A pinion is typically seated on a rotor shaft and meshes with a tooth segment that is part of a rack, for example.

Such a rotary damper is often attached in a stationary part of the housing. A linear guide is furthermore generally provided for the rack and is mounted such that it can pivot about the axis of the rotor shaft and holds the rack in engagement with the pinion, namely regardless of the rotational position of the rack.

The guide enables a translatory movement of the rack in the guide and thus causes a corresponding rotation of the pinion. Any pivoting of the rack is absorbed by the rotating guide. Any movement of the part to be damped therefore results in linear movement in the guide and a corresponding damping by the rotary damper.

In the automotive industry, in particular, there is a need to illuminate optionally scaled or unblocked interior spaces of the part to be damped.

For example, a damper apparatus having an integrated switch is known from the publication WO 2007/080448A1. The switch integrated in the damper apparatus can be electrically connected to a light source located remotely from the damper apparatus, for example in a panel of a glove box. To this end, wiring from the damper apparatus comprising the switch is guided through the panel to the light source. The switch is actuated by a movement of the part, for example of the glove box lid, and thus, for example, when the glove box lid is opened, the light source is switched on.

However, the assembly effort for the known apparatus is relatively high. In particular, the integration of a corresponding switch in the damper apparatus is relatively complex, because a variety of further parts are usually required for this purpose, which must be integrated in a housing of the damper apparatus. The arrangement and geometry of these parts requires a complex assembly process. In addition, the additional parts necessary for the integration of a switching apparatus in the damper apparatus are usually cost-intensive purchased parts.

In addition, in the conventional approaches for integrating a switching apparatus in a damper apparatus, the overall pack size is often inappropriately increased, which is very important for the automobile manufacturer in order to be able to design the glove box size as large as possible, for example.

### SUMMARY

Based on the situation described above, the present invention thus addresses the problem of specifying a damper apparatus for damping, i.e., decelerating, a rotational or linear movement of a part, preferably a part mounted movably in an interior of a vehicle, wherein a switching apparatus is integrated in the damper apparatus, without influencing the damping behavior of the damper apparatus, wherein the pack size of the entire damper apparatus is simultaneously only increased to a small extent. In particular, the damper apparatus is intended to be simple and thus cost-effective to manufacture and mount, while providing a robust supply of an electrical or electronic component, for example a light source.

Accordingly, the present invention relates in particular to a damper apparatus for reducing and in particular braking a movement of a second part movable relative to a first part, wherein the damper apparatus comprises a first damper component, which is in particular fixedly connected or connectable to the first part, and a damping mechanism.

The damping mechanism can optionally comprise a second component, which is connected or connectable, in particularly fixedly, to the second component, in which a second damper component is or can be received at least partially or regionally.

The first damper component is movable relative to the housing of the damping mechanism, at least over a predefined or definable distance of travel. When the first damper component moves relative to the housing of the damper mechanism, the first damper component cooperates with the second damper component at least partially or regionally in the housing of the damper mechanism in such a way that the movement of the first damper component relative to the second damper component and/or the optionally provided housing of the damper mechanism is decelerated.

The damper apparatus according to the invention is characterized in particular in that a switching mechanism is arranged or integrated on the second damper component, for example in the optionally provided housing of the damping mechanism, having a first switching contact and a second switching contact. In particular, it is provided that at least one actuating region is configured on the first damper component such that, in the event of movement of the first damper component relative to the second damper component and/or relative to the optionally provided housing of the damping mechanism, an electrically conductive connection between the first switching contact and the second switching contact is established or disconnected using the at least one actuating region.

The advantages achievable with the damper apparatus according to the invention are obvious:

Due to the fact that the switching mechanism consists only of two parts, namely the first switching contact and the second switching contact, the switching mechanism can be integrated in the housing of the damping mechanism in a particularly easy and simple manner without significantly increasing the design size of the damper apparatus. By using only two parts for the switching mechanism, the production costs of the damper apparatus according to the invention are also very low.

In addition, the switching mechanism can be actuated in an easy-to-implement, yet effective manner using the at least one actuating region of the first damper component. For this purpose, it is provided that the at least one actuating region of the first damper component establishes or disconnects an electrically conductive connection between the first switching contact and the second switching contact when the first damper component moves relative to the second damper component and/or relative to the optionally provided housing of the damping mechanism. Thus, no further parts are necessary in order to actuate the switching mechanism. This, too, has a positive effect on the manufacturing costs as well as on the overall construction or pack size of the damper apparatus.

According to a preferred implementation of the damper apparatus according to the invention, it is provided that the first switching contact and/or the second switching contact are/is embodied as spring contacts and in particular as spring contact pins.

A spring contact or spring contact pin is understood to mean a contacting element, which is supported in a resilient manner. Such a spring contact can consist of a guide tube (also called a pin sleeve or a housing), a spring and a piston, wherein the three parts are preferably installed together by crimping technology in such a way that they can no longer fall apart, but the piston can nevertheless freely carry out a certain spring travel in the longitudinal direction. When installing such a switching contact arranged as a spring contact, the compression spring is preferably pre-tensioned, whereby the spring contact pin already has a certain initial force in its zero position-commonly referred to as preload.

Alternatively, however, it is also conceivable that the first switching contact and the second switching contact are each configured as a contact tab. The contact tab can comprise a contact region, preferably at an end region of the corresponding contact tab.

The two switching contacts of the switching mechanism, which are embodied as contact tabs, are preferably designed to be resilient so that they form a galvanic connection over the two contact regions.

In particular, it is conceivable that the first switching contact comprises a spring contact at a first end region and a plug contact at a second end region opposing the first end region, in particular in the form of a plug-in contact pin, wherein the first switching contact is received or receivable via a plug connection in a plug housing of the switching mechanism (4), said housing being preferably embodied so as to be at least partially or regionally complementary to the plug-in contact.

Alternatively or additionally, it can be appreciated that the second switching contact comprises a spring contact at a first end region and a plug contact at a second end region opposing the first end region, in particular in the form of a plug-in contact pin, wherein the second switching contact is received or receivable via a plug connection in a plug housing of the switching mechanism, said housing being preferably embodied so as to be at least partially or regionally complementary to the plug-in contact.

Particularly preferably, it is provided in this context that the plug housing of the switching mechanism is in particular releasably or exchangeably connected to the second damper component.

It is preferably provided that the first switching contact and the second switching contact of the switching mechanism are identically designed in order to make the construction of the damper apparatus and the switching mechanism integrated in the housing of the damping mechanism particularly easy.

According to implementations of the damper apparatus according to the invention, it is provided that the at least one actuating region of the first damper component is configured so as to retract or extend into a contacting region between the first switching contact and the second switching contact when the first damper component moves relative to the second damper component and/or relative the optionally provided housing of the damping mechanism, and thus to disconnect or establish an electrically conductive connection between the first switching contact and the second switching contact.

This is a particularly easy-to-implement, yet effective solution in order to activate or deactivate the switching mechanism as needed, and in particular based on the relative position of the first damper component. Of course, other embodiments can also be considered here.

In a contemplated implementation, in particular of the previously mentioned design variant of the damper apparatus according to the invention, it is provided that the at least one actuating region of the first damper component is formed from a material that is at least superficially electrically non-conductive and/or is embodied in a fin-like fashion, and wherein the at least one actuating region of the first damper component is in particular embodied as a separating element that can be insertable and withdrawn between the first switching contact and the second switching contact, preferably via a relative movement between the first damper component (2) and the second damper component.

Particularly preferably, it is provided that the second damping mechanism of the damper apparatus according to the invention comprises a blade or rib structure having a plurality of protruding regions, in particular in the form of blades, ribs, or knobs, which are elastically deflectable at least partially or regionally in the direction of movement of the first damper component relative to the second damper component or relative to the housing of the damping mechanism.

In particular, it can be appreciated that the first damper component comprises a ridge structure having at least one and preferably a plurality of teeth or protrusions, wherein, at least in a state in which the first damper component is not moved relative to the second damper component and/or relative to the optionally provided housing of the damping mechanism, the at least one tooth or protrusion of the ridge structure is arranged at least partially or regionally in an intermeshing manner between two adjacent protruding regions of the blade or rib structure.

This design variant offers decisive advantages over the damper apparatuses discussed previously in the introduction to the specification and generally known from the prior art. Due to the fact that, in this design variant of the damper apparatus according to the invention, the functionality of the damping mechanism is not based on the displacement of a working fluid, in particular a hydraulic fluid (oil), or on a gas, in particular air, the damping mechanism (and thus the entire damper apparatus), is much simpler to implement in a constructive sense, wherein at the same time, in a particularly effective manner, a damping characteristic of the damper apparatus can be adjusted, in particular also individually, i.e., in a user-specific manner.

Moreover, the damping characteristic of the damper apparatus is largely independent of ambient conditions, in particular temperature.

In a further development of the last mentioned design variant of the damper apparatus according to the invention, it is provided that the at least one tooth or protrusion of the ridge structure is arranged and/or formed between two adjacent protruding regions of the blade or rib structure such that, upon a movement of the first damper component relative to the second damper component and/or relative to the optionally provided housing of the damping mechanism (and thus relative to the second damper component), at least a portion of the protruding regions of the blade or rib structure is elastically deformed using the at least one tooth or protrusion of the ridge structure while simultaneously converting movement energy into elastic deformation work.

In other words, the damping mechanism used in the damper apparatus according to the invention relies on a functionality in which at least a portion of the initiated kinetic energy is converted into thermal energy by clastic deformation. Preferably, the protruding regions of the blade or rib structure are formed from an elastic material, in particular a plastic material, whose elasticity varies (if at all) only slightly over a temperature range, as far as possible.

Alternatively or additionally, it is preferred that the at least one tooth or protrusion of the ridge structure is formed from a material, in particular a plastic material, that is harder compared to the material of the protruding regions of the blade or rib structure.

According to one aspect, the last mentioned design variant of the damper apparatus according to the invention is characterized in particular in that the protruding regions of the blade or rib structure, when viewed in the cross-section of the protruding regions, have a geometry that at least partially or regionally tapers, in particular conically tapers, in the direction of the ridge structure.

Alternatively or additionally, according to the further aspect of the invention, it can be provided that the at least one tooth or protrusion of the ridge structure, when viewed in the cross-section of the at least one tooth or protrusion, has a geometry that at least partially or regionally tapers, in particular conically tapers, in the direction of the blade or rib structure.

With these measures, it is ensured in each case that the protruding regions of the blade or rib structure unilaterally impact the at least one tooth or protrusion of the ridge structure, whereby a harmonic transmission of force is realized. This reduces any noise produced during operation of the damper apparatus. On the other hand, a harmonic transmission of force ensures a particularly low-wear operation of the damper apparatus.

In this context, in accordance with design variants of the damper apparatus according to the invention, it is provided in particular that the at least one tooth or protrusion of the ridge structure has a shape that is at least regionally at least substantially complementary to the shape of the protruding regions of the blade or rib structure.

This is an easy-to-implement, yet effective measure in order to ensure a transmission of force between the ridge structure and the blade or rib structure that is as harmonic as possible. Such a harmonic transmission of force implies a homogeneous force curve and a flat force amplitude, as a result of which any noises can also be prevented or at least reduced when the damping mechanism or damper apparatus responds.

In principle, it is conceivable that the blade or rib structure comprises a blade or rib support as well as the aforementioned protruding regions connected to the blade or rib support. In this context, it can be appreciated that the blade or rib support is formed from a material, in particular a plastic material, that is harder compared to the material of the protruding regions. Preferably, the blade or rib structure is formed as part of a two-part plastic injection molding process.

This further reduces the cost of manufacture of the damper apparatus according to the invention.

According to a particularly preferred implementation of the damper apparatus according to the invention, it is embodied as a linear damper, in which the first damper component is configured so as to move linearly or at least substantially linearly relative to the second damper component.

Preferably, the second damper component comprises two opposing blade or rib supports, which are embodied so as to form a preferably form-fit and even more preferably at least partially or regionally form-fit sliding guide enabling a translation for a rod-shaped carrier part of the first damper component. Each blade or rib support of the second damper component has a blade or rib structure having a plurality of protruding regions, particularly in the form of blades, ribs, or knobs.

On the other hand, the rod-shaped carrier part of the second damper component preferably comprises a ridge structure having a plurality of teeth or protrusions arranged on opposing lateral surfaces of the rod-shaped carrier part in such a way that, when the rod-shaped carrier part is moved by the sliding guide through the teeth or projections, with simultaneous clastic deflection of the protruding regions of the blade or rib structure of the second damper component, they pass by one another, in particular in an intermeshing manner.

According to a further development of the last mentioned design variant of the damper apparatus according to the invention, it is provided that a distance between the two opposing blade or rib supports of the second damper component is variable in order to thus define a damping factor of the damper apparatus.

In this context, it is conceivable in particular that the two blade or rib supports of the second damper component opposing one another are in a pre-stressed state using a spring element or using spring elements. Likewise, a free-wheel function of the damper apparatus configured as a linear damper can be realized.

Alternatively or additionally, it is conceivable that at least one of the two blade or rib supports of the second damper component opposing one another is slidably mounted relative to the rod-shaped carrier part by way of a guide running obliquely to the direction of movement of the rod-shaped carrier part, and namely in particular such that, upon a movement of the rod-shaped carrier part in a first direction by the sliding guide, the at least one blade or rib support of the second damper component is present in a first position, and, upon a movement of the rod-shaped carrier part in a second direction opposing the first direction by the sliding guide, the at least one blade or rib support of the second damper component is displaced into a second position and/or is present in a second position. In the second position of the at least one blade or rib support of the second damper component, a distance between the two opposing blade or rib supports of the second damper component is greater than in the first position of the at least one blade or rib support of the second damper component.

The distance between the two opposing blade or rib supports of the second damper component in the second position can in particular be selected such that a free-wheeling of the rod-shaped carrier part is possible due to the sliding guide.

In the design variant of the damper apparatus according to the invention, in which the damper apparatus is embodied as a linear damper, the at least one actuating region of the first damper component can be embodied as a region projecting from the rod-shaped carrier part perpendicular to the longitudinal extension direction (and thus perpendicular to the direction of movement) of the rod-shaped carrier part. Preferably, the at least one actuating region of the first damper component is configured at an end region of the rod-shaped carrier part in order to activate or deactivate the switching mechanism when the first part is in its fully extended or fully retracted state relative to the second part.

However, it is of course also conceivable that a plurality of actuating regions are arranged at different positions of the first damper component or the rod-shaped carrier part in order to activate or deactivate the switching mechanism as needed, depending on the movement path of the first damper component.

According to an alternative implementation of the damper apparatus according to the invention, it is embodied as a rotary damper, in which the first damper component is rotatably supported relative to the second damper component.

Here, it can be appreciated that the first damper component is embodied as a sleeve-shaped part, in which at least partially or regionally the second damper component embodied as a pin-shaped part is in particular coaxially and/or concentrically received with a sleeve-shaped blade carrier of the damping mechanism, wherein the at least one actuating region of the first damper component is embodied as a region protruding from the sleeve-shaped part in the longitudinal extension direction of the sleeve-shaped part, and wherein the at least one actuating region of the first damper component is preferably formed at an end region of the sleeve-shaped part.

According to implementations of the damper apparatus according to the invention, the damping mechanism comprises a housing having a first housing region, in which the second damper component is at least partially or regionally received and through which the first damper component is or can be at least partially or regionally guided.

The housing of the damping mechanism further comprises an additional (second) housing region in which the switching mechanism with the first switching contact and the second switching contact is received. In addition, a corresponding electrical circuit or electronics associated with the first and second switching contacts can optionally also be accommodated in the second housing region.

Preferably, a window region is formed between the first housing region and the second housing region, through which the at least one actuating region of the first damper component can be inserted into a region between the first switching contact and the second switching contact. The window region further preferably serves as a guide for guiding the at least one actuating region of the first damper component when the first damper component is moved relative to the housing of the damping mechanism.

Preferably, the second housing region comprises a closure element preferably connected to the base body of the second housing region via a film hinge in order to close the second housing region as needed, in particular in a dust-tight manner.

However, the invention is not limited to damper apparatuses in which at least one damper component has a blade or rib structure with a plurality of protruding regions, in particular in the form of blades, ribs, or knobs.

Rather, the invention also relates to damper apparatuses which are in particular embodied as gas spring dampers and comprise a switching mechanism having a first and a second switching contact.

Thus, according to embodiments, it is provided that the damper apparatus is embodied as a gas spring damper, in which the second damper component comprises an at least regionally or sectionally cylindrical body, in which a piston element of the first damper component is guided linearly in a longitudinal extension direction of the cylindrical body relative to the cylindrical body.

In this design variant of the damper apparatus according to the invention, it is provided in particular that the cylindrical body comprises a first end region facing the switching mechanism and an opposing second end region, wherein the switching mechanism has a corresponding housing structure for at least partially or regionally receiving the first and second switching contact. The housing structure is connected, preferably releasably, to the first end region of the cylindrical body, preferably by way of an end region facing the first end region of the cylindrical body.

Here, it can be appreciated that an end region of the housing structure facing the first end region of the cylindrical body comprises a socket-like or flange-like connecting region, which is configured so as to form an at least partially or regionally positively locking connection with the first end region of the cylindrical body and in particular to at least partially or regionally receive the first end region of the cylindrical body.

In implementations of the damper apparatus according to the invention in which it is designed as a gas spring damper, it is provided that, at the second end region of the cylindrical body, an in particular cap-shaped closure element is arranged, which comprises a guiding and sealing unit, through which a piston rod arranged concentrically to the central longitudinal axis of the cylindrical body and connected to the piston element is retracted out of the cylindrical body.

In implementations of the last mentioned design variant of the damper apparatus according to the invention, it is provided that, in a state of being connected to the first end region of the cylindrical body, the housing structure and the in particular cap-shaped closure element define an interior space of the cylindrical body, wherein, via the piston element, the interior space of the cylindrical body is subdivided into a first housing sub-space facing the switching mechanism and an opposing second housing sub-space.

Preferably, the piston element comprises at least one valve/throttle body, in particular in the form of at least one valve disc, via which a gas exchange between the first and second housing sub-space is possible when the piston element is moved relative to the cylindrical body in an in particular throttled manner.

In design variants of the damper apparatus according to the invention, it is provided that the at least one throttle/valve body is configured such that a speed-based deceleration of the piston element occurs, namely in particular such that a damping by the piston element is greater the faster the piston element is displaced in the cylindrical body relative to the cylindrical body.

The invention further relates to the use of the aforementioned damper apparatus as a movement control apparatus for reducing, and in particular decelerating, a movement of a second part movable relative to a first part.

In addition, the invention relates to a vehicle component, in particular an interior vehicle component, which comprises two parts that can be moved relative to one another, wherein a relative movement of these parts is dampened or reduced using a damper apparatus of the aforementioned type according to the invention.

### BRIEF DESCRIPTION OF THE DRAWINGS

Exemplary embodiments of the damper apparatus according to the invention are described in further detail below with reference to the accompanying drawings. The following are shown:

FIG. 1 schematically and in an isometric view, a first exemplary embodiment of the damper apparatus according to the present invention, which is embodied as a linear damper;

FIG. 2 schematically and in a front view, the exemplary embodiment of the apparatus according to the invention according to FIG. 1;

FIG. 3 schematically and in an isometric view, the first damper component and second damper component as well as the switching mechanism of the exemplary embodiment of the damper apparatus according to the invention according to FIG. 1;

FIG. 4 schematically and in an isometric view, the first damper component of the exemplary embodiment of the damper apparatus according to the invention according to FIG. 1;

FIG. 5 schematically and in an isometric view, the second damper component of the exemplary embodiment of the damper apparatus according to the invention according to FIG. 1;

FIG. 6 schematically, a top plan view of the exemplary embodiment of the damper apparatus according to the invention according to FIG. 1;

FIG. 7 schematically and in an isometric view, a second exemplary embodiment of the damper apparatus according to the present invention, which is embodied as a rotary damper;

FIG. 8 schematically and in an isometric view, the second exemplary embodiment of the damper apparatus according to the invention according to FIG. 7, without the first damper component;

FIG. 9 schematically and in an isometric view, the second exemplary embodiment of the damper apparatus according to the invention according to FIG. 8, without the damping mechanism;

FIG. 10 schematically and in an isometric view, the switching mechanism of the second damper component of the second exemplary embodiment of the damper apparatus according to the invention according to FIG. 7, in cooperation with the actuating region of the first damper component;

FIG. 11 schematically and in an isometric view, a third exemplary embodiment of the damper apparatus according to the present invention;

FIG. 12 schematically, and in a side view, the third exemplary embodiment of the damper apparatus according to FIG. 11, namely in a state in which the piston rod of the first damper component has been retracted from the cylindrical body of the second damper component;

FIG. 13 schematically and in a cross-sectional view, the third exemplary embodiment of the damper apparatus according to the invention according to FIG. 12;

FIG. 14 schematically and in a side view, the third exemplary embodiment of the damper apparatus according to FIG. 11, namely in a state in which the piston rod of the first damper component has been inserted in the insertion direction into the cylindrical body of the second damper component;

FIG. 15 schematically and in a cross-sectional view, the third exemplary embodiment of the damper apparatus according to the invention according to FIG. 14;

FIG. 16 schematically, a top plan view of the housing structure of the third exemplary embodiment of the damper apparatus according to FIG. 11.

### DETAILED DESCRIPTION

The exemplary embodiments of the damper apparatus 1 according to the invention shown in the drawings relate generally to movement control apparatuses for controlling and in particular reducing (decelerating) a movement of a second part movable relative to a first part. In the drawings, the first part and the second part are not shown.

Generally speaking, the exemplary embodiments of the damper apparatus 1 according to the invention comprise a first damper component 2, which is connected or connectable, in particularly fixedly, to the first part (not shown in the drawings) and a damping mechanism.

The damping mechanism comprises a second component 3, which is connected or connectable, in particularly fixedly, to the second component (not shown in the drawings), in which a second damper component 9 is received at least partially or regionally.

The first damper component 2 is movable relative to the housing 3 of the damping mechanism, at least over a predefined or definable distance of travel. When the first damper component 2 moves relative to the housing 3 of the damper mechanism, the first damper component 2 cooperates with the second damper component 9 at least partially or regionally in the housing 3 of the damper mechanism in such a way that the movement of the first damper component 2 relative to the housing 3 of the damper mechanism is decelerated.

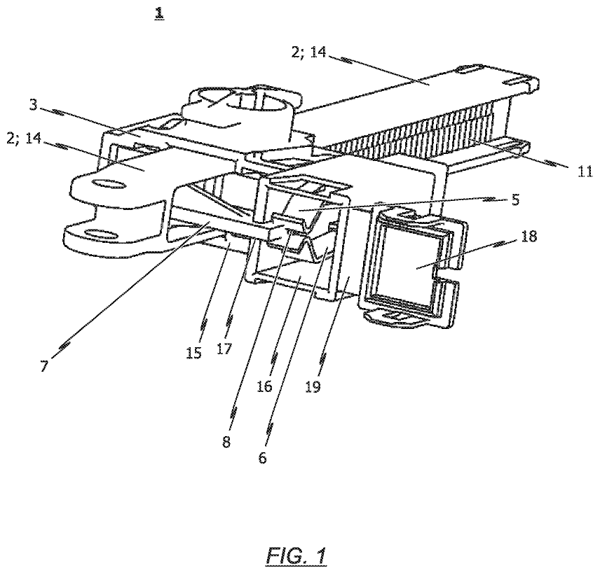

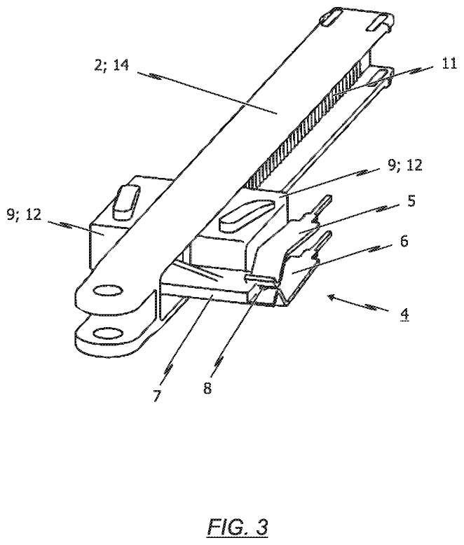

The first exemplary embodiment of the damper apparatus 1 according to the invention is embodied as a linear damper, as shown schematically in FIG. 1 to FIG. 6. It is provided that the first damper component 2 is movable linearly or at least substantially linearly relative to the second damper component 9, wherein this relative movement between the first damper component 2 and the second damper component 9 is decelerated using a damping mechanism.

It can be seen from the illustrations in FIG. 1 to FIG. 3 that a switching mechanism 4 is integrated in the housing 3 of the damping mechanism. The switching mechanism 4 consists of a first switching contact 5 and a second switching contact 6.

On the other hand, at least one actuating region 7 (in the exemplary embodiment of the damper apparatus 1 according to the invention shown in the drawings, exactly one actuating region 7) is formed on the first damper component 2 such that, upon a movement of the first damper component 2 relative to the housing 3 of the damping mechanism, an electrically conductive connection between the first switching contact 5 and the second switching contact 6 is established or disconnected using the actuating region 7 of the first damper component 2.

In the exemplary embodiments of the damper apparatus 1 according to the invention as shown in the drawings, the first switching contact 5 and the second switching contact 6 are identically constructed.

Each switching contact 5, 6 is configured specifically as a contact tab, which preferably comprises a contact region 8 at an end region of the contact tab. The contact tabs of the switching mechanism 4 are designed to be resilient so that they form a galvanic connection via the two contact regions 8.

Alternatively, however, it is also conceivable that the first and/or second switching contact 5, 6 of the switching mechanism 4 is/are embodied as spring contacts and in particular as spring contact pins.

The at least one actuating region 7 of the first damper component 2 is configured so as to retract or extend into a contact region 8 between the first switching contact 5 and the second switching contact 6 when the first damper component 2 moves relative to the housing 3 of the damping mechanism, and thus to disconnect or establish an electrically conductive connection between the first switching contact 5 and the second switching contact 6 of the switching mechanism 4.

As can be seen in particular from the illustration in FIG. 5, the second damper component 9, which is at least partially or regionally received in the housing 3 of the damping mechanism, comprises a blade or rib structure 10 having a plurality of protruding regions, in particular in the form of blades, ribs, or knobs, which are elastically deflectable at least partially or regionally in the direction of movement of the first damper component 2 relative to the second damper component 9.

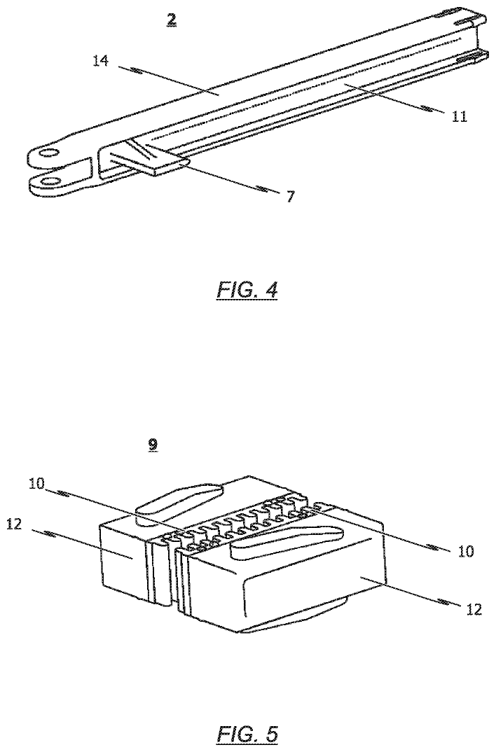

On the other hand, the damping mechanism 2, as can be seen in particular from the illustration in FIG. 4, comprises a ridge structure 11 having at least one and preferably a plurality of teeth or protrusions, wherein, at least in a state in which the first damper component 2 is not moved relative to the housing 3 of the damping mechanism, the at least one tooth or protrusion of the ridge structure 11 is arranged at least partially or regionally in an intermeshing manner between two adjacent protruding regions of the blade or rib structure 10 of the second damper component 9.

It is provided that the at least one tooth or protrusion of the ridge structure 11 is arranged and/or formed between two adjacent protruding regions of the blade or rib structure 10 of the second damper component 9 such that, upon a movement of the first damper component 2 relative to the housing 3 of the damping mechanism, at least a portion of the protruding regions of the blade or rib structure 10 is elastically deformed using the at least one tooth or protrusion of the ridge structure 11 of the first damper component 2 while simultaneously converting movement energy into elastic deformation work.

In the damper apparatus 1, which is embodied as a linear damper, according to the first exemplary embodiment as shown in the drawings, the second damper component 9, which is at least partially or regionally received in the housing 3 of the damping mechanism, comprises two opposing blade or rib supports 12 (cf. FIG. 5), which are designed in order to form a preferably positively locking and even more preferably at least partially or regionally positively locking sliding guide that allows translation for a rod-shaped carrier part 14 (cf. FIG. 4) of the first damper component 2.

It can also be seen in the illustration in FIG. 5 that each blade or rib support 12 of the second damper component 9 has a corresponding blade or rib structure 10 with a plurality of protruding regions. The protruding regions are in particular regions in the form of blades, ribs, or knobs.

On the other hand, the rod-shaped carrier part 14 of the second damper component 2, as can be seen in the isometric view of FIG. 4, comprises a ridge structure 11 having a plurality of teeth or protrusions arranged on opposing lateral surfaces of the rod-shaped carrier part 14 in such a way that, when the rod-shaped carrier part 14 is moved by the sliding guide through the teeth or projections of the ridge structure 11 of the first damper component 2, with simultaneous clastic deflection of the protruding regions of the blade or rib structure 10 of the second damper component 9, they pass by one another, in particular in an intermeshing manner.

From the isometric view in FIG. 4, it can further be seen that (in the exemplary embodiment of the damper apparatus 1 shown, exactly) one actuating region 7 of the first damper component 2 is configured as a region projecting from the rod-shaped carrier part 14 perpendicular to the longitudinal extension direction of the rod-shaped carrier part 14.

Specifically, the actuating region 7 of the first damper component 2 is configured at an end region of the rod-shaped carrier part 14.

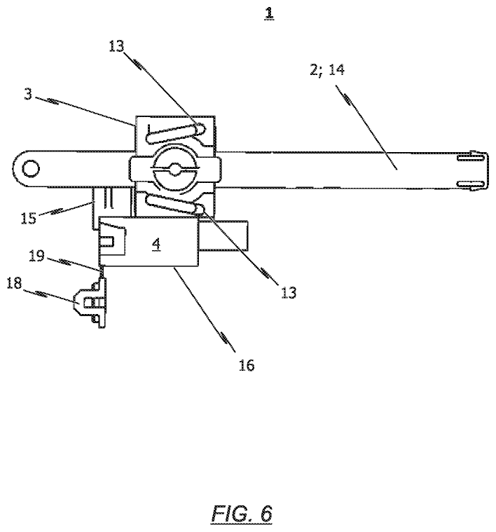

As can be seen in particular from the top plan view according to FIG. 6, the two opposing blade or rib supports 12 of the second damper component 9 are slidably supported in the housing 3 of the damping mechanism relative to the rod-shaped carrier part via a guide 13 that extends obliquely to the direction of movement of the rod-shaped carrier part 14.

It is thus achieved that, upon a movement of the rod-shaped carrier part 14 in FIG. 6 to the right, the two blade or rib supports 12 of the second damper component 9 are in a first position, and upon a movement of the rod-shaped carrier part 14 in FIG. 6 to the left, the two blade or rib supports 12 are displaced in a second position.

In the first position of the two blade or rib supports 12 of the second damper component 9, a distance between the two opposing blade or rib supports 12 is greater than in the first position of the two blade or rib supports 12.

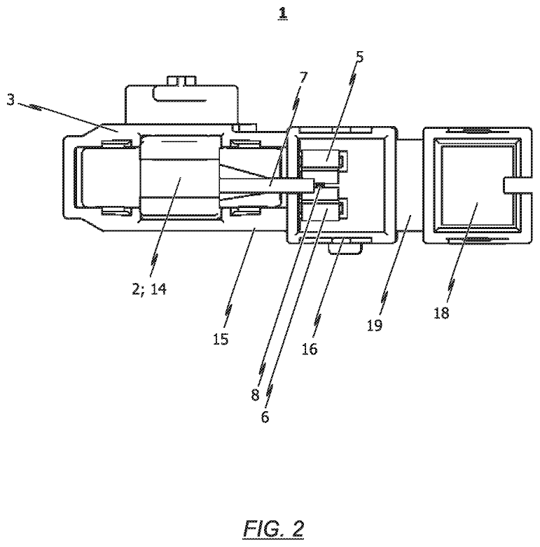

As can be seen in particular from the isometric view in FIG. 1 or the frontal view in FIG. 2, the housing 3 of the damping mechanism is subdivided into a first housing region 15 in which the second damper component 9 (cf. FIG. 5) is at least partially or regionally received and through which the first damper component 2, and in particular the rod-shaped carrier part 14, is guided at least partially or regionally.

The housing 3 of the damping mechanism comprises a second housing region 16 in which the switching mechanism 4 with the first switching contact 5 and the second switching contact 6 is received.

A window region 17 is formed between the first housing region 15 and the second housing region 16, through which the actuating region 7 of the first damper component 2 can be inserted into a region (contact region 8) between the first switching contact 5 and the second switching contact 6.

Furthermore, the second housing region 16 comprises a closure element 18 preferably connected to a base body of the second housing region 16 via a film hinge 19 in order to close the second housing region 16 as needed.

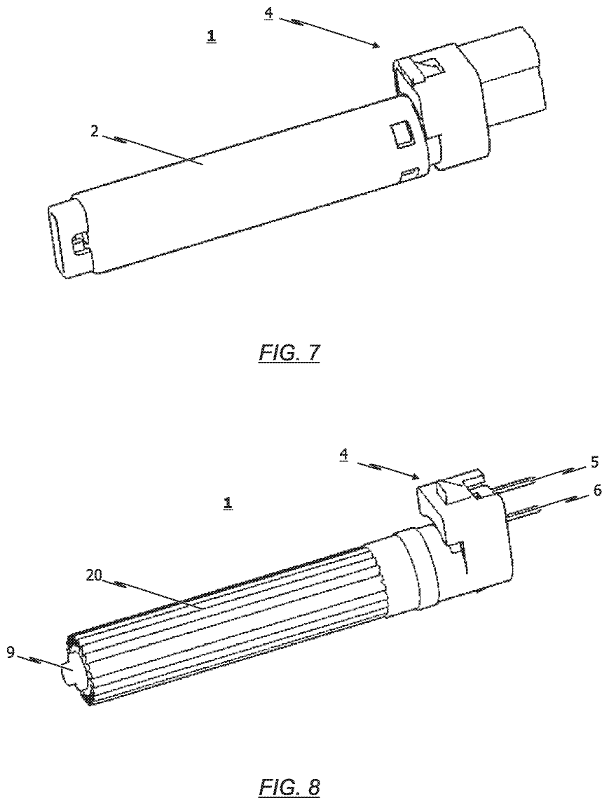

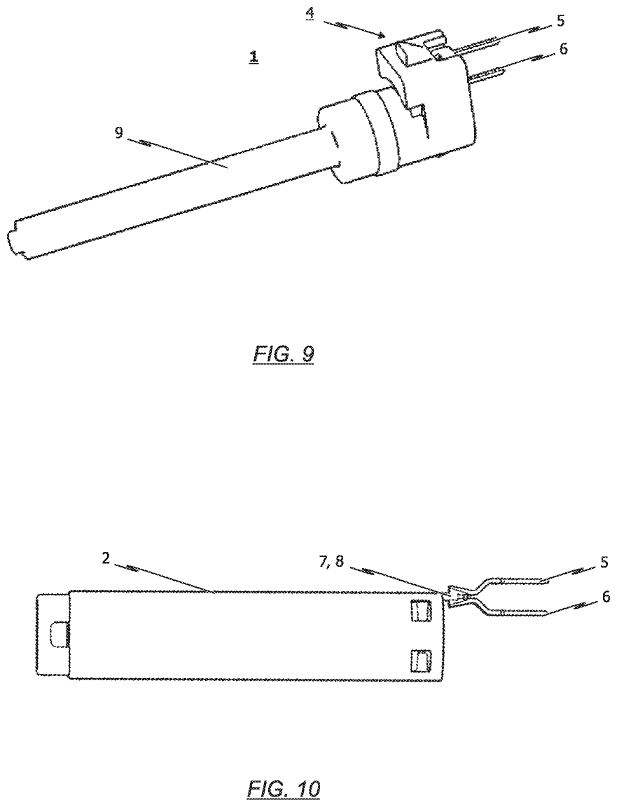

The second exemplary embodiment of the damper apparatus 1 according to the invention is embodied as a rotary damper, as shown schematically in FIG. 7 to FIG. 10.

Here, the first damper component 2 is rotatable relative to the second damper component 9, wherein the rotational movement of the first damper component 2 relative to the second damper component 9 is decelerated by a corresponding damping mechanism 20.

Specifically, the first damper component 2 of the second exemplary embodiment of the damper apparatus 1 according to the invention is embodied as a sleeve-shaped part. Inside the first damper component 2, which is embodied as a sleeve-shaped part, the second damper component 9 is received at least partially or regionally. This is a pin-shaped region.

Moreover, in the interior of the sleeve-shaped first damper component 2, the damping mechanism 20 is received. This is a sleeve-shaped blade structure supported by the pin-shaped second damper component 9. The blade structure of the sleeve-shaped damper mechanism 20 reduces a rotational movement of the first damper component 2 relative to the second damper component 9.

A switching mechanism 4 is formed on the second damper component 9. The switching mechanism 4 comprises a first switching contact 5 as well as a second switching contact 6.

On the other hand, as indicated in FIG. 10, an actuating region 7 is configured on the first damper component 2 such that, in the event of rotational movement of the first damper component 2 relative to the second damper component 9, an electrically conductive connection is established or disconnected between the first switching contact 5 and the second switching contact 6 using the actuating region 7.

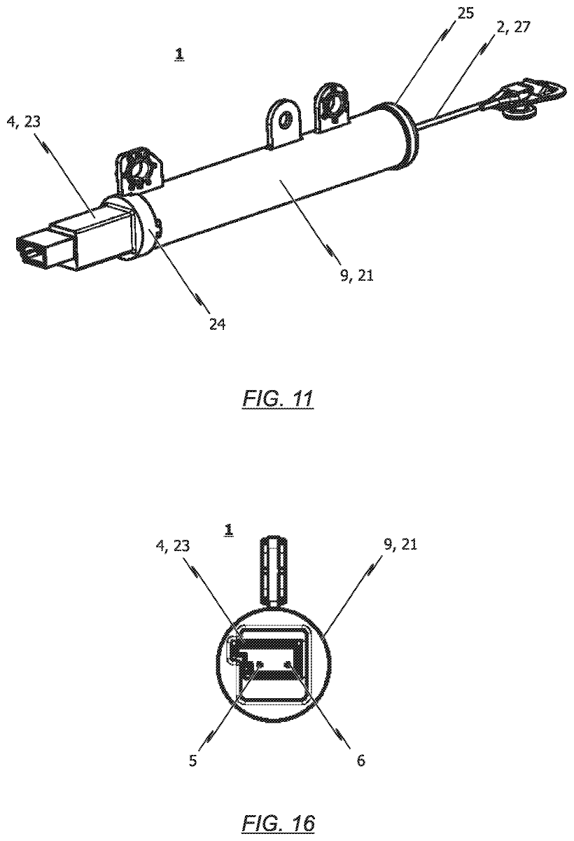

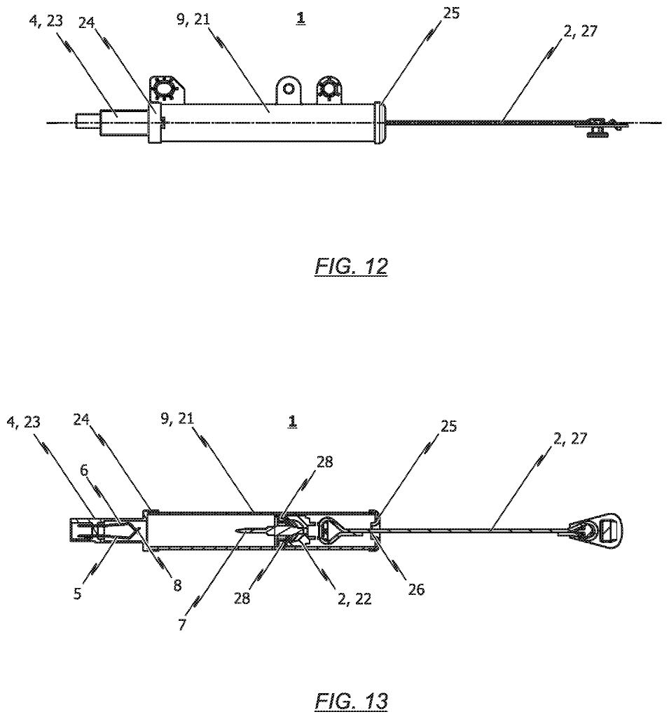

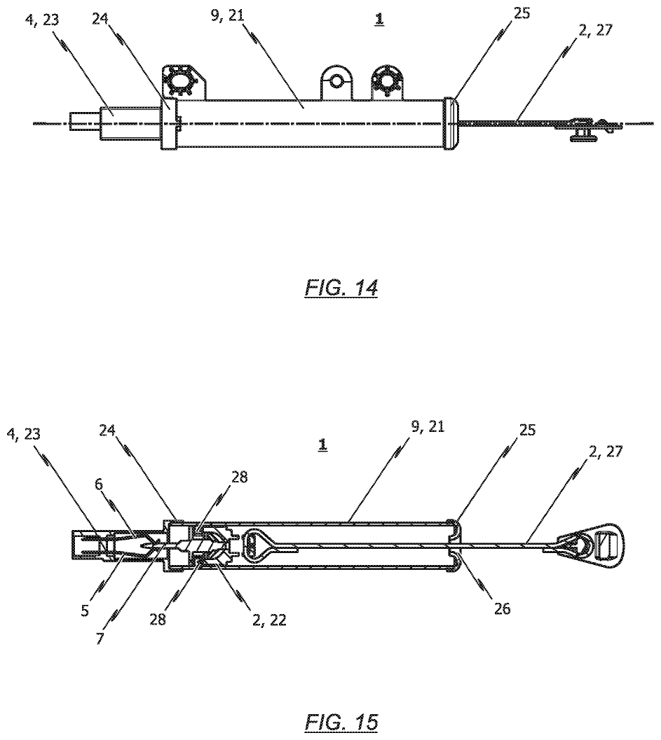

A further exemplary embodiment of the damper apparatus 1 according to the invention is described in the following with reference to the illustrations in FIG. 11 to FIG. 16.

The damper apparatus 1 of this embodiment is embodied as a linear damper and in particular a gas spring damper. The second damper component 9 comprises an at least regionally or sectionally cylindrical body 21, in which a piston element 22 of the first damper component 2 is guided linearly in a longitudinal extension direction of the cylindrical body 21 relative to the cylindrical body 21.

Moreover, according to the exemplary embodiment shown in FIG. 11 to FIG. 16, the damper apparatus 1 comprises a switching mechanism 4 having a first switching contact 5 and a second switching contact 6. The first and second switching contacts 5, 6 of the switching mechanism 4 are accommodated at least regionally in a housing structure 23 of the switching mechanism 4 and preferably connected therein in a material-locking manner to the housing structure 23. The housing structure 23 itself is connected, preferably releasably, to the first end region of the cylindrical body 21 by way of an end region facing the first end region of the cylindrical body 21 facing the switching mechanism 4.

For this purpose, an end region of the housing structure 23 facing the first end region of the cylindrical body 21 comprises a socket-like or flange-like connecting region 24, which is configured so as to form an at least partially or regionally positively locking connection with the first end region of the cylindrical body 21 and in particular to at least partially or regionally receive the first end region of the cylindrical body 21.

On the other hand, a cap-shaped closure element 25 is arranged at the second end region of the cylindrical body 21 opposing the first end region of the cylindrical body 21.

With the aid of the housing structure 23 of the switching mechanism 4 arranged on the first region of the cylindrical body 21 and the cap-shaped closure element 25 arranged on the second end region of the cylindrical body 21, on the other hand, the interior space of the cylindrical body 21 is at least substantially gas-tight against the external atmosphere.

To guide a piston rod 27 connected to the piston element 22 out of the cylindrical body 21, a guiding and sealing unit 26 is formed in the cap-shaped closure element 25, through which the piston rod 27 arranged concentrically to the central longitudinal axis of the cylindrical body 21 and connected to the piston element 22 is guided out of the cylindrical body 21.

In a state of being connected to the first end region of the cylindrical body 21, the housing structure 23 and the in particular cap-shaped closure element 25 define an interior space of the cylindrical body 21, wherein, via the piston element 22, the interior space of the cylindrical body 21 is subdivided into a first housing sub-space facing the switching mechanism 4 and an opposing second housing sub-space.

It is conceivable that the piston element 22 comprises at least one valve/throttle body 28, for example in the form of at least one valve disc, via which a gas exchange between the first and the second housing sub-space is possible when the piston element 22 is moved relative to the cylindrical body 21 in an in particular throttled manner.

However, it is also conceivable that the piston element 22 comprises a circumferential seal with which, even upon a movement of the piston element 22 relative to the cylindrical body 21, a gas exchange between the first and the second housing sub-space is at least substantially prevented.

Moreover, it is conceivable that piston element 22 can comprise a valve/throttle body 28, in particular in the form of two valve discs, such that a speed-based deceleration of the piston element 22 occurs, in particular such that a damping by the piston element 22 is greater the faster the piston element 22 is displaced in the cylindrical body 21 relative to the cylindrical body 21.

To actuate the switching mechanism 4, an actuating region 7 is provided on the piston element 22 in the form of a pin-shaped region, which, in a state when the piston element 22 is moved towards the switching mechanism 4, disconnects an electrically conductive connection between the first switching contact 5 and the second switching contact 6.

The two switching contacts 5, 6 are preferably identically constructed and in particular embodied as spring contacts, preferably as spring contact pins.

The invention is not limited to the embodiments of the damper apparatus according to the invention as shown in the drawings, but rather results when all of the features disclosed herein are considered together.

### LIST OF REFERENCE NUMERALS

1 Damper apparatus
2 First damper component
3 Housing
4 Switching mechanism
5 First switching contact
6 Second switching contact
7 Actuating region
8 Contacting region
9 Second damper component
10 Blade or rib structure of the second damper component
11 Ridge structure of the first damper component
12 Blade or rib support
13 Guide
14 Rod-shaped carrier part
15 First housing region
16 Second housing region
17 Window region
18 Closure element
19 Film hinge
20 Damping mechanism
21 Cylindrical body
22 Piston element
23 Housing structure
24 Socket/flange-like connecting region
25 Closure element
26 Guiding and sealing unit
27 Piston rod
28 Valve/throttle body

1. A damper apparatus for braking a movement of a second part movable relative to a first part, wherein the damper apparatus comprises the following:
a first damper component, which is fixedly connected or connectable to the first part;
a second damper component, which is in particular fixedly connected or connectable to the second part; and
a damping mechanism,
wherein the first damper component is movable relative to the second damper component, at least over a predefined or definable distance of travel, and wherein movement of the first damper component relative to the second damper component is or can be decelerated due to the damping mechanism,
characterized in that
a switching mechanism with a first switching contact and a second switching contact is arranged or integrated on the second damper component, wherein at least one actuating region is configured on the first damper component (2) in such a way that when the first damper component moves relative to the second damper component, an electrically conductive connection is established or disconnected between the first switching contact and the second switching contact using the at least one actuating region of the first damper component.

2. The damper apparatus according to claim 1,
wherein the first switching contact and/or the second switching contact is/are embodied as a spring contact.

3. The damper apparatus according to claim 1,
wherein the first switching contact and the second switching contact are each embodied as contact tabs, each of which comprises a contact region, at an end region of the corresponding contact tab, wherein the contact tabs are embodied resiliently such that they form a galvanic connection over the two contact regions.

4. The damper apparatus according to claim 1,
wherein the first switching contact comprises a spring contact at a first end region and a plug contact at a second end region opposing the first end region, in the form of a plug-in contact pin, wherein the first switching contact is received or receivable via a plug connection in a plug housing of the switching mechanism, said housing being embodied so as to be at least partially or regionally complementary to the plug-in contact; and/or
wherein the second switching contact comprises a spring contact at a first end region and a plug contact at a second end region opposing the first end region, in the form of a plug-in contact pin, wherein the second switching contact is received or receivable via a plug connection in a plug housing of the switching mechanism, said housing being embodied so as to be at least partially or regionally complementary to the plug-in contact.

5. The damper apparatus according to claim 4,
wherein the plug housing of the switching mechanism is releasably or exchangeably connected to the second damper component.

6. The damper apparatus according to claim 1,
wherein the first switching contact and the second switching contact are identically constructed.

7. The damper apparatus according to claim 1,
wherein the at least one actuating region of the first damper component is configured so as to retract or extend into a contact region between the first switching contact and the second switching contact when the first damper component moves relative to the second damper component, and thus to disconnect or establish an electrically conductive connection between the first switching contact and the second switching contact.

8. The damper apparatus according to claim 7, wherein the at least one actuating region of the first damper component is formed from a material that is at least superficially electrically non-conductive and/or is embodied in a fin-like fashion, and wherein the at least one actuating region of the first damper component is embodied as a separating element that can be insertable and withdrawn between the first switching contact and the second switching contact, via a relative movement between the first damper component and the second damper component.

9. The damper apparatus according to claim 1,
wherein the second damper component comprises a blade or rib structure having a plurality of protruding regions, in the form of blades, ribs, or knobs, which are at least partially or regionally elastically deflectable in the direction of movement of the first damper component relative to the second damper component,
wherein the first damper component comprises a ridge structure having at least one and a plurality of teeth or protrusions, wherein, at least in a state in which the first damper component is not moved relative to the second damper component, the at least one tooth or protrusion of the ridge structure is arranged at least partially or regionally in an intermeshing manner between two adjacent protruding regions of the blade or rib structure.

10. The damper apparatus according to claim 9,
wherein the at least one tooth or protrusion of the ridge structure is arranged and/or formed between two adjacent protruding regions of the blade or rib structure such that, upon a movement of the first damper component relative to the second damper component, at least a portion of the protruding regions of the blade or rib structure is elastically deformed using the at least one tooth or protrusion of the ridge structure while simultaneously converting movement energy into elastic deformation work.

11. The damper apparatus according to claim 1,
wherein the damper apparatus is embodied as a linear damper, in which the first damper component is configured so as to move linearly or at least substantially linearly relative to the second damper component.

12. The damper apparatus according to claim 11,
wherein the second damper component comprises two opposing blade or rib supports, which are embodied so as to form a at least partially or regionally form-fit sliding guide enabling a translation for a rod-shaped carrier part of the first damper component, wherein each blade or rib support of the second damper component comprises a blade or rib structure having a plurality of protruding regions, and wherein the rod-shaped carrier part of the first damper component has a ridge structure with a plurality of teeth or protrusions arranged on opposing lateral surfaces of the rod-shaped carrier part in such a way that, when the rod-shaped carrier part is moved by the sliding guide, with simultaneous elastic deflection of the protruding regions of the blade or rib supports of the second damper component, the teeth or protrusions pass through them, in an intermeshing manner.

13. The damper apparatus according to claim 12,
wherein a distance between the two opposing blade or rib supports is variable in order to define a damping factor of the damper apparatus.

14. The damper apparatus according to claim 12,
wherein at least one of the two blade or rib supports lying opposing one another is slidably mounted relative to the rod-shaped carrier part by way of a guide running obliquely to the direction of movement of the rod-shaped carrier part, and such that, upon a movement of the rod-shaped carrier part in a first direction by the sliding guide, the at least one blade or rib carrier is present in a first position, and that upon a movement of the rod-shaped carrier part in a second direction opposing to the first direction by the sliding guide, the at least one blade or rib carrier is displaced into a second position and/or is present in a second position,
wherein, in the second position of the at least one blade or rib support, a distance between the two opposing blade or rib supports is greater than in the first position of the at least one blade or rib support.

15. The damper apparatus according to claim 12,
wherein the at least one actuating region of the first damper component is configured as a region protruding from the rod-shaped carrier part perpendicular to the longitudinal extension direction of the rod-shaped carrier part, and wherein the at least one actuating region of the first damper component is configured at an end region of the rod-shaped carrier part.

16. The damper apparatus according to claim 1,
wherein the damper apparatus is embodied as a rotary damper, in which the first damper component is rotatably supported relative to the second damper component.

17. The damper apparatus according to claim 16,
wherein the first damper component is embodied as a sleeve-shaped part, in which at least partially or regionally the second damper component embodied as a pin-shaped part is coaxially and/or concentrically received with a sleeve-shaped blade carrier of the damping mechanism, wherein the at least one actuating region of the first damper component is embodied as a region protruding from the sleeve-shaped part in the longitudinal extension direction of the sleeve-shaped part, and wherein the at least one actuating region of the first damper component is formed at an end region of the sleeve-shaped part.

18. The damper apparatus according to claim 1,
wherein the damping mechanism comprises a housing having a first housing region, in which the second damper component is received at least partially or regionally, and through which the first damper component is guided at least partially or regionally, and wherein the housing of the damping mechanism comprises a second housing region, in which the switching mechanism with the first switching contact and the second switching contact is received, wherein a window region is formed between the first housing region and the second housing region, through which the at least one actuating region of the first damper component can be inserted into a region between the first switching contact and the second switching contact.

19. The damper apparatus according to claim 18,
wherein the second housing region comprises a closure element connected to a base body of the second housing region via a film hinge for the as-needed closure of the second housing region.

20. The damper apparatus according to claim 1,
wherein the damper apparatus is embodied as a linear damper, in which the first damper component is configured so as to move linearly or at least substantially linearly relative to the second damper component.

21. The damper apparatus according to claim 20,
wherein the damper apparatus is embodied as a gas spring damper, in which the second damper component comprises an at least regionally or sectionally cylindrical body, in which a piston element of the first damper component is guided linearly in a longitudinal extension direction of the cylindrical body relative to the cylindrical body.

22. The damper apparatus according to claim 21,
wherein the cylindrical body comprises a first end region facing the switching mechanism and an opposing second end region, wherein, for at least partially or regionally receiving the first and second switching contact, the switching mechanism comprises a housing structure, wherein the housing structure is connected, preferably releasably, to the first end region of the cylindrical body via an end region facing the first end region of the cylindrical body.

23. The damper apparatus according to claim 22,
wherein an end region of the housing structure facing the first end region of the cylindrical body comprises a socket-like or flange-like connecting region, which is configured so as to form an at least partially or regionally positively locking connection with the first end region of the cylindrical body.

24. The damper apparatus according to claim 22,
wherein, at the second end region of the cylindrical body, a cap-shaped closure element is arranged, which comprises a guiding and sealing unit, through which a piston rod arranged concentrically to the central longitudinal axis of the cylindrical body and connected to the piston element is retracted out of the cylindrical body.

25. The damper apparatus according to claim 24,
wherein, in a state of being connected to the first end region of the cylindrical body, the housing structure and the cap-shaped closure element define an interior space of the cylindrical body, wherein, via the piston element, the interior space of the cylindrical body is subdivided into a first housing sub-space facing the switching mechanism and an opposing second housing sub-space.

26. The damper apparatus according to claim 25,
wherein the piston element comprises at least one valve/throttle body, in the form of at least one valve disc, via which a gas exchange between the first and second housing sub-space is possible when the piston element is moved relative to the cylindrical body in an in particular throttled manner.

27. The damper apparatus according to claim 26,
wherein the at least one throttle/valve body is configured such that a speed-based deceleration of the piston element occurs, such that a damping by the piston element is greater the faster the piston element is displaced in the cylindrical body relative to the cylindrical body.
